(19) United States
(12) Patent Application Publication
(10) Pub. No.: US 2007/0051902 A1
(43) Pub. Date: Mar. 8, 2007

(54) Apparatus for reducing contaminants in fluid stream comprising a dielectric barrier excimer discharge lamp

(76) Inventors: Thomas Justel, Witten (DE); Dietrich Bertram, Aachen (DE)

Correspondence Address: PHILIPS INTELLECTUAL PROPERTY & STANDARDS, P.O. BOX 3001, BRIARCLIFF MANOR, NY, 10510, US

(21) Appl. No.: 10/566,550

(22) PCT Filed: Jul. 21, 2004
(86) PCT No.: PCT/IB04/51275

§ 371 Date: Jan. 27, 2006

(51) Int. Cl. G01N 23/00

(52) U.S. Cl. 250/455.11

(57) ABSTRACT

An apparatus for reducing contaminants in a fluid stream, the apparatus comprising at least one light source for producing radiant energy to produce radicals in the fluid stream, whereby the light source is a dielectric barrier excimer discharge lamp.

The present invention relates to an apparatus for reducing contaminants in a fluid stream, preferably to an apparatus for reducing pollutants in the exhaust gases produced by the combustion of fuel.

The lamps conventionally used to provide such treatment have been low-pressure mercury lamps that emit vacuum ultraviolet radiation at a wavelength of 185 nm, which is the resonant line of mercury. Such low-pressure mercury lamps are described in, for example, U.S. Pat. No. 6,047,543 and PCT/US96/20581.

U.S. Pat. No. 6,047,543 discloses an apparatus and a method for enhancing the rate of a chemical reaction in a gas stream. The apparatus includes at least one heterogeneous catalyst having an upstream end and a downstream end, and at least one surface having a plurality of catalytically active sites on the surface, where the catalyst is positioned so that at least a portion of the gas stream contacts at least a portion of the catalytically active sites on the surface. At least one device for producing radicals or other active species from at least one of water vapour or other gaseous species, such as a corona discharge device or a UV light source is used to produce radicals or other active species, which are introduced into the gas stream at a position upstream of the downstream end of the catalyst. The radicals or other active species are introduced in an amount sufficient to reduce or eliminate poisoning of the catalyst by catalyst poisons, such as sulphur, sulphur containing compounds, phosphorous, phosphorous containing compounds, and carbon.

PCT/US96/20581 discloses a method and apparatus for reducing pollutants in the exhaust gases produced by an internal combustion engine. In one embodiment, ozone, produced by ultraviolet radiation having a wavelength of 185 nanometers, is introduced into the intake of a combustion engine to provide a more complete reduction of fuel, improved efficiency and fewer pollutants. In a different embodiment, ozone is introduced into the combustion gas stream and thereafter the exhaust gases are treated by a catalytic converter resulting in a further reduction of pollutants than if the catalytic converter alone was used to treat the exhaust gases. In a different embodiment, a method and apparatus is provided for reducing pollutants in the exhaust gases produced from the combustion of a fuel by introducing hydroxyl into the exhaust gas stream of the combustion engine upstream of the catalytic converter and treating the exhaust gases with the catalytic converter.

However, mercury (Hg) low pressure discharge lamps have the drawback of a strong temperature dependence of their efficiency. Further, the problematic of the presence of Hg for the environment is well known. Since the application of hazardous elements, such as Hg, has to be avoided, these lamps are not desired in automotive applications. Also, there is a significant risk that Hg low pressure discharge lamps exhibit a material fatigue which can lead to a release of Hg. The release of Hg can affect unfavourably the catalytic activity of a metal base catalyst. However, the presence of catalyst poisons that may be adsorbed onto the catalyst surface in any of the fuel, oxidizer, or reaction products will degrade the performance and the efficiency of the catalytic process by occupying active sites on the catalyst surface. This reduces for example the number of sites available to the fuel and oxidizer, decreasing the reaction rate.

Therefore, a need exists for a simple, pollution free, inexpensive light source having a long life and maintaining the efficiency of an apparatus for reducing contaminants in a fluid stream as well as avoiding the above disadvantages.

Accordingly, it is an object of one embodiment of the present invention to provide an apparatus for reducing contaminates in a fluid stream.

Another object of the present invention is to provide an apparatus for reducing contaminates in the exhaust gases of a combustion engine, preferably contaminants in vehicles such as automobiles or trucks exhaust gases using a fuel, such as gasoline, methanol and/or diesel, wherein radiant energy is employed to convert oxygen in air to ozone upstream of the air intake valve of the engine to provide a more complete combustion of fuel and improved efficiency without the need for major modifications to the internal combustion engine or catalytic converter.

A further object of one embodiment of the invention is to provide an apparatus for reducing pollutants in a fluid stream, such as hydrogen, methanol, oxygen or there like, for a fuel cell.

The object according to the present invention is solved by an apparatus for reducing contaminants in a fluid stream, the apparatus comprising at least one light source for producing radiant energy to produce radicals in the fluid stream, whereby the light source is a dielectric barrier excimer discharge lamp.

The fluid stream can be a gas stream or liquid stream, preferably the fluid stream is a gas stream.

Dielectric barrier excimer discharge lamp as used according to the present invention are free of mercury.

The use of dielectric barrier excimer discharge lamps for reducing contaminants in a fluid stream is favourable for the following reasons:—Light output is constant between −150 and +500° C.; and/or—long lifetime even for fast switching cycles; and/or—fast run-up to full output power, also enabling fast switching cycles and reducing warm-up problems; and/or—relaxed geometry constraints, allowing better integration into a system.

Dielectric-barrier discharge lamps produce excimer emissions by containing a gas for excimer emissions in a discharge vessel made up of a dielectric and bringing about a dielectric-barrier discharge. Such dielectric-barrier discharge lamps can have a hollow- cylinder-shaped discharge space, made up of quartz glass of which at least a part is dielectric, and is filled with a gas for excimer emissions.

Further, the apparatus of the present invention can comprise a transformer for driving the at least one light source; and/or a connector for connecting the transformer to an electrical system of the engine;

Dielectric-barrier discharge lamps (DBD) source generate UV/VUV output from excimer molecules. A high electrical efficiency of at least ≧20%, preferably ≧30, more preferably ≧40% is achieved for the Xe excimer discharge if pulse high-voltage AC driving is used. In a dielectric-barrier discharge lamps configuration one electrode or both are separated from the plasma by an insulating dielectric layer, and the discharge consists of a series of short-lived narrow filamentary channels and/or micro-discharges that occur stochastically in time. Although the majority of dielectric-barrier discharge lamps have traditionally been powered using AC voltage waveforms, according to the present invention short-pulsed excitation can have important advantages. In particular, the dielectric-barrier discharge lamp efficiency for VUV production from a Xe₂* lamp (172 nm) can be dramatically increased by a factor of at least two, preferably three or more compared to AC excitation by using fast excitation pulses of ≦1 microseconds (μs) duration followed by idle periods of about 100 microseconds (μs).

According to the present invention the duration of excitation pulses can be ≦1000 microseconds and ≧100 nanoseconds, preferably ≦500 microseconds and ≧1 microseconds and more preferably ≦100 microseconds and ≧10 microseconds.

The idle periods according to the present invention can be ≦10000 μs and ≧1 microseconds, preferably ≦1000 microseconds and ≧10 microseconds and more preferably ≦100 microseconds and ≧10 microseconds.

The output is generated in short pulses of much higher peak power from homogeneous discharges or micro-discharges appearing as cone or funnel shaped structures rather than narrow filaments.

The emission spectrum and efficiency of the dielectric-barrier discharge lamp is dependent on the filling gas, whereby several wavelength between 126 and 351 nm can be obtained as depicted in table 1.

TABLE 1
Peak emission wavelength and efficiency of dielectric-barrier discharge
lamps for sinus drive as function of the filling gas

| Filling | Emission | Efficiency |
|---|---|---|
| gas (excimer) | wavelength [nm] | [%] |
| Ar (Ar₂*) | 126 | 10 |
| Kr (Kr₂*) | 146 | 15 |
| Xe (Xe₂*) | 172 | >40 |
| Kr, Cl₂ (KrCl*) | 222 | 18 |
| Xe, Cl₂ (XeCl*) | 308 | 14 |
| Xe, F₂ (XeF*) | 351 | >10 |

The efficiency of the Xe excimer discharge lamp exceed ≧40% and is thus especially preffered.

The spectrum can be further modified if needed by one or more phosphors, coated onto the inner side of the quartz tube, to optimize the effect in the specific reaction targeted. For instance, for the efficient decomposition of benzene, which is widely applied as a component in fuel up to 2 wt.-% using radiation in the range of 180 nm to 210 nm. This wavelength range can be addressed by Nd³⁺ activated phosphors.

NOₓ which is present in the exhaust gas of combustion engines, can be cleaved by radiation with a wavelength below 240 nm, which is accessible by Pr³⁺ phosphors. Efficient UV-C emitting phosphors for Xe excimer discharge lamps are for example LaPO₄:Pr, YPO₄:Nd, YPO₄:Pr, LuPO₄:Pr, or YPO₄:Bi.

It is also possible, that the phosphor itself acts as functional surface element, which is then coated on the inside of the converter structure and functions under illumination with the above mentioned lamp. In other words, the catalytic surface layer is then additionally activated by light from the lamp.

This type of catalytic converter of the present invention can be used for many purposes. The most preferred one is the use in cars with combustion engines, where it can greatly enhance the efficiency and safety over the existing solutions.

By use of a dielectric-barrier discharge lamp according to the present invention ionizing the species prior to reaction by means of UV light significantly enhance these reactions taking place in a converter compared to Hg low pressure discharge lamps. Hydroxyl ion “OH” and other free radicals and oxidizers such as O, H, HO, and H₂O₂, can be generated in a fluid stream to reduce pollutants and contaminants. Further oxygen in a fluid stream inducted by a dielectric-barrier discharge lamp to ozone, wherein the ozone increases the efficiency of combustion of fuel by the engine thereby reducing the amount of hydrocarbons and carbon monoxide in the fluid stream, e.g. exhaust gases.

For example said radicals can be generated in and/or introduced into the combustion gas stream of a combustion engine to reduce pollutants and contaminants such as CO and hydrocarbons. It has been observed that OH in the presence of oxygen can react rapidly with CO to produce CO₂. It has also been observed that OH in the presence of oxygen can react rapidly with hydrocarbons to produce formaldehyde or other similar intermediary products which then further react with OH to form H₂O, CO₂ and OH. Moreover, there is evidence that the series of reactions do not consume, but rather regenerates OH.

The OH and other related free radicals and oxidizers created in the reactions can act as a catalyst independent of or in conjunction with the normal catalytic function of the precious metal particles such as Pt, Pd, Rh and combinations thereof in a catalytic converter.

As catalysts precious metal particles such as Pt. Pd, Rh and/or combinations thereof are preferred. However, as a catalyst material TiO₂, preferably a porous structure of TiO₂, can be used also. The porous structure should be selected such that the fluid stream can flow through.

According to an embodiment the apparatus of the present invention comprises at least one heterogeneous and/or homogeneous catalyst having an upstream end and a downstream end, and at least one surface having a plurality of catalytically active sites on the surface the catalyst positioned such that at least a portion of the gas stream contacts at least a portion of the catalytically active sites on the surface.

It is preferred that the dielectric barrier excimer discharge lamp as used according of the present invention comprises a filling gas containing a noble gas selected from the group of Argon, Krypton and/or Xenon, whereby Xenon is preferred. The filling gas can comprise further a halogen gas such as Fluor and/or Chlor.

The filling gas pressure of a dielectric barrier excimer discharge lamp used for the present invention can be 50 mbar to 600 mbar. The filling gas pressure is measured at room temperature.

The dielectric barrier excimer discharge lamp can comprise a filling gas of:—0 weight-% to 100 weight-% Argon, preferrably 10 weight-% to 90 weight-% Argon, more preferrably 20 weight-% to 80 weight-% Argon; and/or
0 weight-% to 100 weight-% Krypton, preferrably 10 weight-% to 90 weight-% Krypton, more preferrably 20 weight-% to 80 weight-% Krypton; and/or
0 weight-% to 100 weight-% Neon, preferrably 10 weight-% to 90 weight-% Neon, more preferrably 20 weight-% to 80 weight-% Neon; and/or
0 weight-% to 100 weight-% Xenon, preferrably 10 weight-% to 90 weight-% Xenon, more preferrably 20 weight-% to 80 weight-% Xenon, based on the total weight of filling gas in the dielectric barrier excimer discharge lamp, whereby the total sum of fillings should not exceed 100 weight-% of the total weight of filling gas in the dielectric barrier discharge lamp. The lamp can also contain mixtures of the above mentioned fillings, whereby the total sum of fillings should not exceed 100 weight-% of the total weight of filling gas in the dielectric barrier discharge lamp.

It is preferred further that the dielectric barrier excimer discharge lamp comprise a phosphor material, whereby the phosphor material is preferably selected from the group of YPO₄:Nd, YPO₄:Bi, YPO₄:Pr, LuPO₄:Pr and/or LaPO₄:Pr, more preferably a mixture thereof.

In order to improve the reduction of contamination in an fluid stream it is desired that the dielectric barrier excimer discharge lamp has the maximum emission intensity or maximum peak at a wavelength of between:
150 nm and 200 nm, preferably 160 nm and 190 mn, more preferably 170 nm and 180 nm; or
160 nm and 230 nm, preferably 170 nm and 210 nm, more preferably 175 nm and 190 nm; or
220 nm and 250 nm, preferably 225 nm and 249 nm, more preferably 230 nm and 248 nm.

These and other objects, advantages and features of the invention will become apparent from the following drawings, which illustrate the invention. In the drawings:

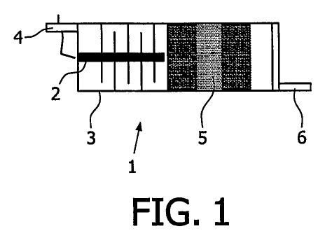

FIG. 1 shows an example of an UV assisted catalytic converter with a dielectric barrier excimer discharge lamp without phosphor and suprasil;

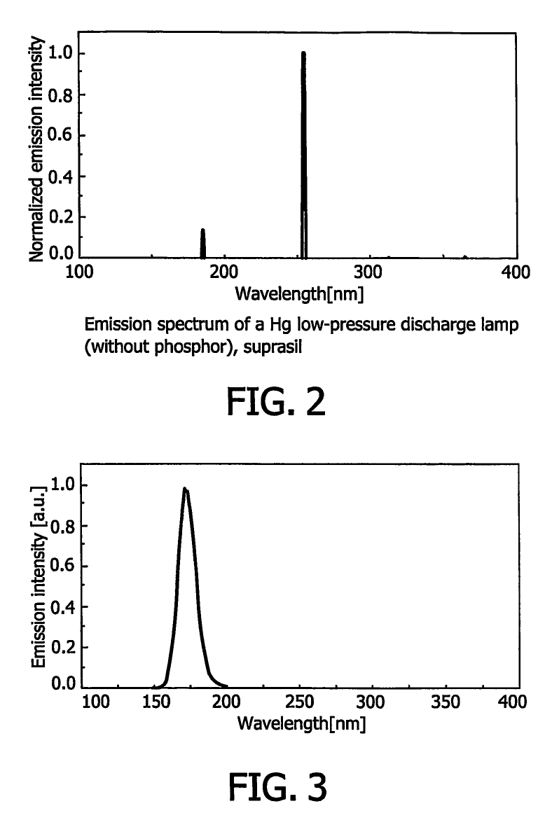

FIG. 2 shows an emission spectrum of a UV assisted catalytic converter with a dielectric barrier excimer discharge lamp (without phosphor), suprasil;

FIG. 3 shows an emission spectrum of a DB Xe₂* excimer discharge lamp (without phosphor), suprasil;

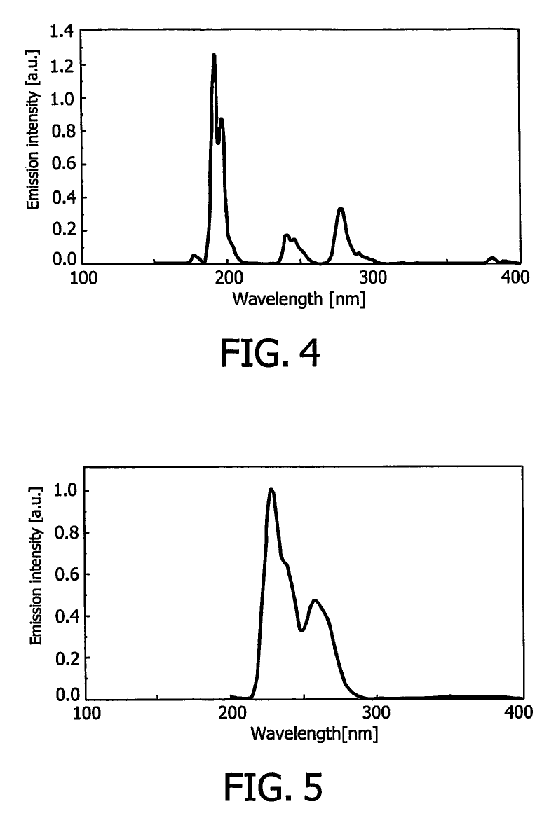

FIG. 4 shows an emission spectrum of a DB Xe₂* excimer discharge lamp with YPO4: 1 wt.-% Nd;

FIG. 5 shows an emission spectrum of a DB Xe₂* excimer discharge lamp with LaPO₄: 1 wt.-% Pr;

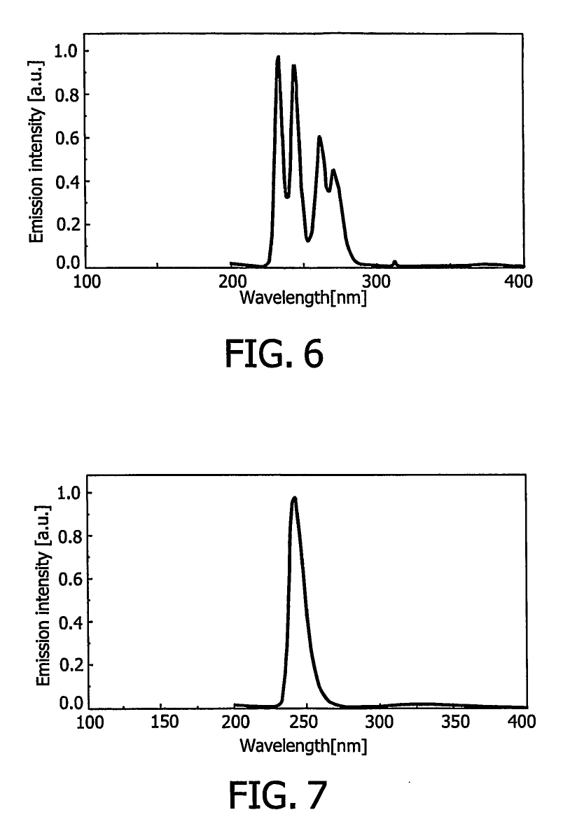

FIG. 6 shows an emission spectrum of a DB Xe₂* excimer discharge lamp with YPO₄: 1 wt.-% Pr, suprasil;

FIG. 7 shows an emission spectrum of a DB Xe₂* excimer discharge lamp with YPO₄: 1 wt.-% Bi, suprasil.

According to one embodiment of the present invention an apparatus for reducing contamination in a fluid stream having a combustion chamber with a precombustion gas stream to the combustion chamber and a postcombustion gas stream of exhaust from the combustion chamber, wherein at least one dielectric barrier excimer discharge lamp is positioned in the precombustion gas stream.

According to a second embodiment of the present invention a common converter is used and than modified to accommodate a dielectric barrier excimer discharge lamp, which needs to be placed in front of the converter structure. The exhaust gas will stream around the dielectric barrier excimer discharge lamp, emitting UV light, which breaks the bonds of the incoming molecules of a fluid stream and releases a fluid stream of ionized materials, which will react, e.g. in a second zone, to the desired products.

According to a third embodiment of the present invention an apparatus for reducing contamination in said liquid stream having at least one sensor. A sensor can be used to control and/or to adjust the fluid stream rate, pollutant load of the fluid and/or the function of the dielectric barrier excimer discharge lamp. For instant in case of a malfunction of a first dielectric barrier excimer discharge lamp a second dielectric barrier excimer discharge lamp can be activated. It is also possible to activate a number of dielectric barrier excimer discharge lamps, preferably at least two, more preferably at least three, dependent of the pollutant load of the fluid.

According to a fourth embodiment of the present invention an apparatus is presented containing a dielectric barrier excimer discharge lamp inserted into an container, which is connected to an inlet tube. The container further comprises a porous structure of TiO₂. The inner part of the container is formed such, that the incoming fluid streams passing first the part of the container containing the dielectric barrier excimer discharge lamp and then streams through the porous TiO₂ structure. The fluid is decomposed into ionic species, which can further react at the TiO₂ surface to harmless species. The resulting fluid is released through the exit port of the container.

According to another embodiment of the present invention the fluid stream is a liquid stream. An apparatus for reducing contamination in said liquid stream having a prechamber liquid stream to the contamination reduction chamber and a post liquid stream from the contamination reduction chamber, wherein at least one dielectric barrier excimer discharge lamp is positioned in the apparatus, preferably in the contamination reduction chamber.

The apparatus according to the present invention can be used for treating fluid stream to reduce the concentration of at least one pollutant of a fluid, preferably for treating an exhaust gas stream from the combustion of a fuel in an engine to reduce the concentration of at least one pollutant of said gas stream, more preferably to reduce the concentration of at least one pollutant of the fluid of an fuel cell.

However, the apparatus according to the present invention can be preferably used for cleaning of industrial exhaust lines, for production of chemicals or for use as a reformer to generate hydrogen on board of a vehicle to supply a combustion engine or a fuel cell generating electrical current.

To illustrate the principle of the present invention in FIG. 1 an apparatus (1) is shown containing a Xe dielectric barrier excimer discharge lamp (2) inserted into a metal encasing (3), which is connected to the exhaust pipe system of a combustion engine by an inlet tube (4). The container further comprises a porous structure of TiO₂ (5). The inner part of the metal enclosure is formed so, that the incoming gas moves around the lamp and then streams through the porous TiO₂ structure. The gas is decomposed into ionic species, which react at the TiO₂ surface to harmless species. The resulting gas is released through the exit port (6) of the metal casing.

1. An apparatus for reducing contaminants in a fluid stream, the apparatus comprising at least one light source for producing radiant energy to produce radicals in the fluid stream, whereby the light source is a dielectric barrier excimer discharge lamp.

2. The apparatus according to claim 1 comprises at least one heterogeneous and/or homogeneous catalyst having an upstream end and a downstream end, and at least one surface having a plurality of catalytically active sites on the surface the catalyst positioned such that at least a portion of the fluid stream contacts at least a portion of the catalytically active sites on the surface.

3. The apparatus according to claim 1, whereby the dielectric barrier excimer discharge lamp comprises a filling gas comprising a noble gas selected from the group of Argon, Krypton and/or Xenon, whereby Xenon is preferred.

4. The apparatus according to claim 1, whereby the dielectric barrier excimer discharge lamp has filling gas pressure of 50 mbar to 600 mbar.

5. The apparatus according to claim 1, whereby the dielectric barrier excimer discharge lamp comprises:—0 weight.-% to 100 weight.-% Argon; and/or —0 weight.-% to 100 weight.-% Krypton; and/or —0 weight.-% to 100 weight.-% Xenon; based on the total weight of filling gas in the dielectric barrier excimer discharge lamp.

6. The apparatus according to claim 1, whereby the dielectric barrier excimer discharge lamp comprises a phosphor material, whereby the phosphor material is preferably selected from the group of YPO₄:Nd, YPO₄:Bi, YPO₄:Pr, LuPO₄:Pr and/or LaPO₄:Pr, more preferably a mixture thereof.

7. The apparatus according to claim 1, whereby the dielectric barrier excimer discharge lamp has the maximum emission intensity at a wavelength of between:—150 nm and 200 nm, preferably 160 nm and 190 nm, more preferably 170 nm and 180 nm; or—160 nm and 230 nm, preferably 170 nm and 210 nm, more preferably 175 nm and 190 nm; or—220 nm and 250 nm, preferably 225 nm and 249 nm, more preferably 230 nm and 248 nm.

8. The apparatus according to claim 1, whereby the dielectric barrier excimer discharge lamp is pulsed operated.

9. The apparatus according to claim 1, having a combustion chamber with a precombustion gas stream to the combustion chamber and a postcombustion gas stream of exhaust from the combustion chamber, wherein at least one dielectric barrier excimer discharge lamp is positioned in the precombustion gas stream.

10. Use of an apparatus according to claim 1 for treating fluid stream to reduce the concentration of at least one pollutant of a fluid, preferably for treating an exhaust gas stream from the combustion of a fuel in an engine to reduce the concentration of at least one pollutant of said gas stream, more preferably reduce the concentration of at least one pollutant of the fluid of an fuel cell.
